(19) United States
(12) Patent Application Publication
(10) Pub. No.: US 2005/0232611 A1
(43) Pub. Date: Oct. 20, 2005

(54) Portable audio video data recording control device

(75) Inventor: Zheng-Tie Sun, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/085,536

(22) Filed: Mar. 22, 2005

(30) Foreign Application Priority Data
Apr. 14, 2004 (TW) 93110386

(51) Int. Cl. H04N 5/781

(52) U.S. Cl. 386/125; 386/126

(57) ABSTRACT

A portable audio video data recording control device for controlling a recorder is provided. The recording control device includes a first I/O interface, a control unit, an audio video encoder and a second I/O interface. The control unit is for accessing the audio video data of the camcorder via the first I/O interface. The audio video encoder is for encoding the audio video data of the camcorder accessed by the control unit into an encoded data. The portable audio video data recording control device transmits the encoded data to the recorder via the second I/O interface. So that, the recorder can store the encoded data in an optical storage medium.

This application claims the benefit of Taiwan application Serial No. 93110386, filed Apr. 14, 2004, the subject matter of which is incorporated herein by reference.

### BACKGROUND OF THE INVENTION

1. Field of the Invention

The invention relates in general to a portable audio video data recording control device, and more particularly to a recording control device fast converting digital video (DV) films.

2. Description of the Related Art

Along with the advance in technology, the audio video data specification of camcorders has evolved from Beta and video home system (VHS) specification to digital video cassette recorder (VCR) specification, i.e., digital video camcorder specification, which has become the mainstream specification nowadays.

Of the so-called DVs, the consumer DV camcorder, which adopts 1/4 inch (6.35 mm) metal evaporated track is also called mini-DV. Of the DV cassettes, the standard playback (SP) mode DV adopts 10 μm track interval with the capacity of 60 minutes per volume of cassette is, while a long playback (LP) mode adopts 6.7 μm track to have a longer recording time with the capacity of 90 minutes per volume of cassette.

Besides, with the rapid development in optical storage medium, CD/DVD disc has nowadays been widely used in data back-up due to the advantage of high storage capacity of DVD disc. It has become a popular trend to burn and convert a DV film into a CD/DVD disc for collection purpose.

The conversion routine of DV film is normally executed by computer. That is to say, audio video compression software is pre-installed in a computer system for compressing a DV film into audio video data of MPEG format to be recorded in a recorder after the DV film has been downloaded to the computer.

However, both downloading a DV film and converting into an MPEG format are time-consuming, which would take a number of hours, and the length of time depend on the efficiency of the computer system. Furthermore, from downloading to recording is a complicated procedure and causes inconvenience to the user.

Besides, the recorder according to prior art cannot separate from the computer system during burning. The recorder relies on the CPU of the computer system to access and convert the DV film into audio video data of recordable MPEG format. When the DV cassette is full, a computer system is required for the recorder to proceed with recording routine. However, an ordinary computer system is huge in size with poor portability. Even a notebook computer still has a certain volume and weight. Quite often the user has to give up recording a DV film for the lack of a computer system at hand. Unlike a DVD disc, which is slim and compact, a DV cassette is a burden both in space and weight. This is indeed a big problem for a person who travels afar or lack of a computer system.

### SUMMARY OF THE INVENTION

It is therefore an object of the invention to provide a portable audio video data recording control device, with the features of slimness and portability, instantly converting the audio video data of the camcorder into a data format required by recorder to real time recorded onto an optical storage medium without using a computer system.

The invention achieves the above-identified object by providing a portable audio video data recording control device for controlling a recorder. The recording control device includes a first input/output (I/O) interface, a control unit, an audio video encoder and a second I/O interface. The control unit is for accessing the audio video data of the camcorder via the first I/O interface. The audio video encoder if for encoding the audio video data of the camcorder accessed by the control unit into encoded data. The portable audio video data recording control device transmits the encoded data to the recorder via the second I/O interface. So that, the recorder can store the encoded data in an optical storage medium.

The invention achieves the above-identified object by providing a portable audio video data recording control device for controlling a recorder. The recording control device includes a first IEEE 1394 interface, a control unit, an audio video encoder and a second IEEE 1394 interface. The control unit is for accessing the audio video data of the camcorder via the first IEEE 1394 interface. The audio video encoder if for encoding the audio video data of the camcorder accessed by the control unit into encoded data. The portable audio video data recording control device transmits the encoded data to the recorder via the second IEEE 1394 interface. So that, the recorder can store the encoded data in an optical storage medium.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a portable audio video data recording control device according to a preferred embodiment of the invention.

### DETAILED DESCRIPTION OF THE INVENTION

The portable audio video data recording control device of the invention is exemplified by a preferred embodiment below.

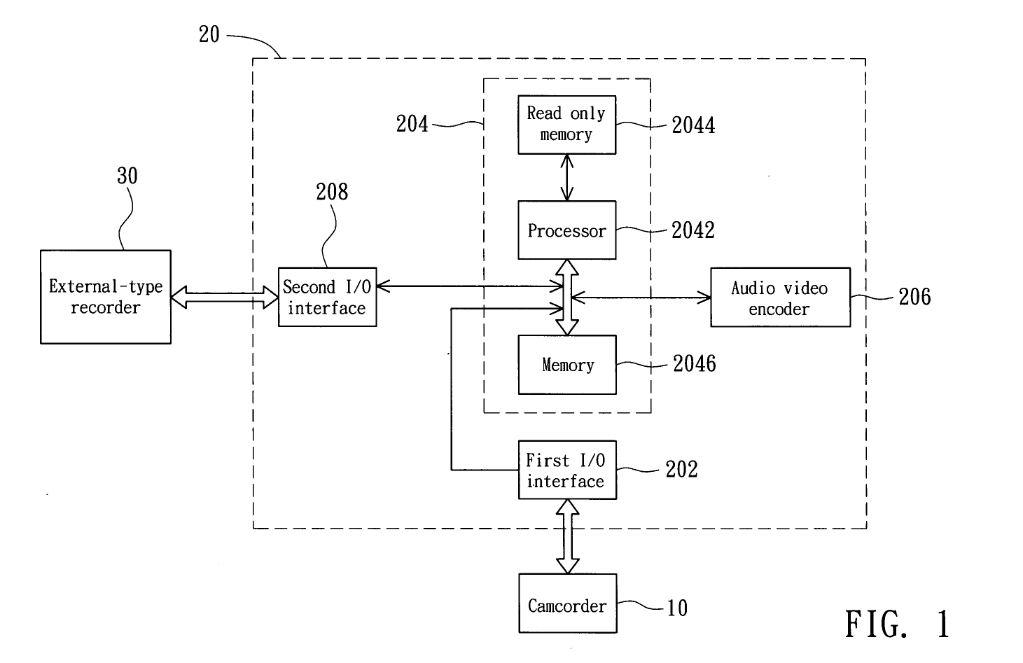

Referring to FIG. 1, a schematic diagram of a portable audio video data recording control device according to a preferred embodiment of the invention is shown. The portable audio video data recording control device 20 can directly control an external-type recorder 30 to real time record the audio video data of the camcorder 10 without using any computer system. The recording control device 20 includes a first input/output (I/O) interface 202, a control unit 204, an audio video encoder 206 and a second I/O interface 208. The first I/O interface 202 and the second I/O interface 208, such as IEEE 1394 interfaces or USB interfaces, can support large volume data transmission.

The control unit 204, via the first I/O interface 202, can access the audio video data recorded by the camcorder 10 to be transmitted to the audio video encoder 206. The camcorder 10 can be a digital video (DV) camcorder. The camcorder 10 includes an interface (unshown in FIG. 1) for electrically connecting to the first I/O interface. The interface of the camcorder 10 includes an IEEE 1394 interface or an USB interface.

The audio video encoder 206 compresses and encodes the audio video data accessed by the control unit 204 into an encoded data. After that, the control unit 204, via the second I/O interface 208, transmits the encoded data to the external-type recorder 30 for the recorder 30 to store the encoded data in an optical storage medium such as a DVD disc. The external-type recorder 30 includes an interface (unshown in FIG. 1) for electrically connecting to the first I/O interface. The interface of the external-type recorder 30 includes an IEEE 1394 interface or an USB interface.

The audio video encoder 206 encodes the received audio video data into an MPEG audio video compression format. MPEG-1 format and MPEG-2 format are commonly seen MPEG audio video compression formats. Generally speaking, VCD disc adopts MPEG-1 format; meanwhile, the recorder 30 can be an external-type recorder such as CD-R/RW, CD+R/RW or CD±R/RW. DVD disc adopts MPEG-2 format mostly; meanwhile, the external-type recorder 30 is an external-type DVD recorder.

The control unit 204 at least includes a processor 2042, a read only memory 2044 and a memory 2046. The processor 2042 stores the audio video data accessed by the first I/O interface 202 in the memory 2046. Meanwhile, the audio video data stored in the memory 2046 are unprocessed source data, so the processor 2042 instructs the audio video encoder 206 to encode the audio video data. The read only memory 2044 has a routine of the control device 20.

If the processor 2042 and the audio video encoder 206 are system on chips (SOC), the recording control device 20 can have the volume effective reduced and the conversion efficiency further enhanced. In other words, the audio video compression software according to prior art needs to use the resources of computer system for encoding, so the encoding speed cannot meet the requirement of real time recording. The audio video encoder 206, especially in the presence of system on chip, can significantly enhance the speed of encoding, for example, instantly converting a DV film into an MPEG-2 format. Therefore, the recording control device 20 is not only portable, but also capable of real time converting the DV film and recording onto CD/DVD disc.

It can be seen from the above disclosure that the portable audio video data recording control device according to the preferred embodiment of the invention has the advantages of being small in size, low in cost, convenient in portability, and having real time recoding function. The portable audio video data recording control device, which dispenses the use of spacious and heavy DV cassettes, is practical to those who travel frequently or those who do not want to buy a complete set computer system.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A portable audio video data recording control device for controlling an external-type recorder, wherein the portable audio video data recording control device comprises:
a first input/output (I/O) interface;
a control unit for accessing the audio video data of a camcorder via the first I/O interface;
an audio video encoder for encoding the audio video data of the camcorder accessed by the control unit into an encoded data; and
a second I/O interface through which the portable audio video data recording control device transmits the encoded data to the external-type recorder, wherein the external-type recorder stores the encoded data in an optical storage medium.

2. The portable audio video data recording control device according to claim 1, wherein the first I/O interface includes an IEEE 1394 interface or an universal serial bus (USB) interface.

3. The portable audio video data recording control device according to claim 1, wherein the second I/O interface includes an IEEE 1394 interface or an USB interface.

4. The portable audio video data recording control device according to claim 1, wherein the camcorder is a digital video (DV) camcorder.

5. The portable audio video data recording control device according to claim 4, wherein the audio video encoder converts the audio video data of the camcorder into a MPEG-2 format or a MPEG-1 format.

6. The portable audio video data recording control device according to claim 1, wherein the external-type recorder is a DVD recorder.

7. The portable audio video data recording control device according to claim 1, wherein the external-type recorder is a CD-R/RW recorder, a CD+R/RW recorder or a CD±R/RW recorder.

8. The portable audio video data recording control device according to claim 1, wherein the control unit comprises:
a memory for storing the audio video data of the camcorder and the encoded data; and
a processor for driving the external-type recorder and recording the encoded data onto the optical storage medium via the second I/O interface.

9. The portable audio video data recording control device according to claim 8, wherein the processor is a system on chip (SOC).

10. The portable audio video data recording control device according to claim 1, wherein the audio video encoder is a system on chip.

11. A portable audio video data recording control device for controlling an external-type recorder, wherein the portable audio video data recording control device comprises:
a first IEEE 1394 interface;
a control unit for accessing the audio video data of a camcorder via the first IEEE 1394 interface;
an audio video encoder for encoding the audio video data of the camcorder accessed by the control unit into an encoded data; and
a second IEEE 1394 interface through which the portable audio video data recording control device transmits the encoded data to the external-type recorder, wherein the external-type recorder stores the encoded data in an optical storage medium.

12. The portable audio video data recording control device according to claim 11, wherein the camcorder is a digital video camcorder.

13. The portable audio video data recording control device according to claim 11, wherein the audio video encoder converts the audio video data of the camcorder into a MPEG format.

14. The portable audio video data recording control device according to claim 11, wherein the external-type recorder is a DVD recorder.

15. The portable audio video data recording control device according to claim 11, wherein the external-type recorder is a CD-R/RW recorder, a CD+R/RW recorder or a CD±R/RW recorder.

16. The portable audio video data recording control device according to claim 11, wherein the control unit comprises:
a memory for storing the audio video data of the camcorder and the encoded data; and
a processor for driving the external-type recorder and recording the encoded data onto the optical storage medium via the second I/O interface.

17. The portable audio video data recording control device according to claim 16, wherein the processor is a system on chip.

18. The portable audio video data recording control device according to claim 11, wherein the audio video encoder is a system on chip.
